(19) United States
(12) Patent Application Publication
(10) Pub. No.: US 2025/0053525 A1
(43) Pub. Date: Feb. 13, 2025

(54) INPUT/OUTPUT EXPANDER REGISTER ADDRESSING

(71) Applicant: Micron Technology, Inc., Boise, ID (US)

(72) Inventors: Gyan Prakash, Bangalore (IN); Jose Rey C. De Luna, Boise, ID (US); Srinivasa Aditya Regulagadda, Vijayawada (IN)

(21) Appl. No.: 18/790,156

(22) Filed: Jul. 31, 2024

Related U.S. Application Data
(60) Provisional application No. 63/518,050, filed on Aug. 7, 2023.

(51) Int. Cl. G06F 13/20

(52) U.S. Cl. CPC G06F 13/20; G06F 2213/40

(57) ABSTRACT

A method includes receiving, via a decoder coupled to a feature register resident on a memory device interface that comprises a first feature register portion and a second feature portion, a bit string comprising at least one bit indicative of selection between the first feature register portion and the second feature register portion, and responsive to the at least one bit being indicative of selecting the first feature register portion, writing the bit string to at least one memory die among a plurality of memory dice addressed by the first feature register portion, or responsive to the at least one bit being indicative of selecting the second feature register portion, writing the bit string to at least one memory die among a plurality of memory dice addressed by the second feature register portion.

### PRIORITY INFORMATION

This application claims the benefit of U.S. Provisional Application No. 63/518,050, filed on Aug. 7, 2023, the contents of which are incorporated herein by reference.

### TECHNICAL FIELD

Embodiments of the disclosure relate generally to memory sub-systems, and more specifically, relate to input/output (IO) expander (IOE) register addressing.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the disclosure.

FIG. 2 illustrates a system that includes a multi-channel input/output expander in accordance with some embodiments of the disclosure.

FIG. 3 illustrates a device for IO expander register addressing in accordance with some embodiments of the disclosure.

FIG. 4 illustrates a system for IO expander register addressing in accordance with some embodiments of the disclosure.

FIG. 5 illustrates a system for IO expander register addressing in accordance with some embodiments of the disclosure.

FIG. 6 illustrates a system for IO expander register addressing in accordance with some embodiments of the disclosure.

FIG. 7 is a flow diagram corresponding to a method for IO expander register addressing in accordance with some embodiments of the disclosure.

FIG. 8 is a block diagram of an example computer system in which embodiments of the disclosure may operate.

### DETAILED DESCRIPTION

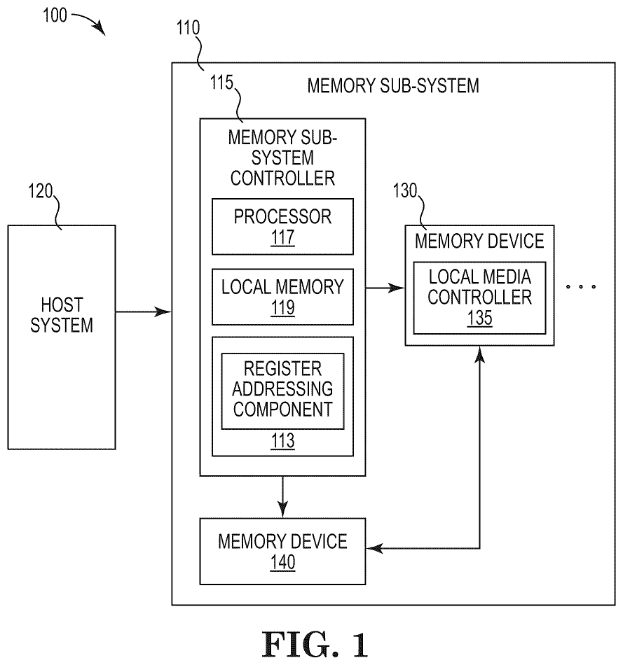

Aspects of the present disclosure are directed to IO expander register addressing, in particular to memory sub-systems that include a register addressing component. A memory sub-system can be a storage system, storage device, a memory module, or a combination of such. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative-and (NAND) memory device (also known as flash technology). As used herein, a NAND memory device can include either a set of flash memory dice or a combination of the flash memory dice and a non-volatile memory (NVM) controller. The NVM controller can include circuitry for performing read/write operations as described herein. Other examples of non-volatile memory devices are described below in conjunction with FIG. 1. A non-volatile memory device is a package of one or more dice. Each die can consist of one or more planes. Planes can be grouped into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A block hereinafter refers to a unit of the memory device used to store data and can include a group of memory cells, a word line group, a word line, or individual memory cells. For some memory devices, blocks (also hereinafter referred to as “memory blocks”) are the smallest area that can be erased. Pages cannot be erased individually, and only whole blocks can be erased.

Each of the memory devices can include one or more arrays of memory cells. Depending on the cell type, a cell can be written to in order to store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple level cells (TLCs), and quad-level cells (QLCs). For example, a SLC can store one bit of information and has two logic states.

Some NAND memory devices employ a floating-gate architecture in which memory accesses are controlled based on a relative voltage change between the bit line and the word lines. Other examples of NAND memory devices can employ a replacement-gate architecture that can include the use of word line layouts that can allow for charges corresponding to data values to be trapped within memory cells based on properties of the materials used to construct the word lines.

In some previous approaches, an input/output expander (IOE) device can be placed between a host and memory dice. For example, an IOE device can be placed between a host device and a plurality of NAND dies (or “LUNs”). In some embodiments, the IOE device can be referred to as a buffer chip or buffer chip device. The host side of the IOE device can be referred to as a front end and the memory dice side of the IOE device can be referred to as the back end. The IOE device can allow a host to see a single die load at the IOE device front end (e.g., front side (FS), etc.). The NAND die loads can be distributed across multiple IOE back end (e.g., back side (BS), etc.) channels. These previous IOE devices can implement a crossbar switch to route the intended traffic to target NAND dies. As used herein, a crossbar switch includes a collection of switches arranged in a matrix configuration. A crossbar switch can have multiple input and output lines that form a crossed pattern of interconnecting lines between which a connection may be established by closing a switch located at each intersection, the elements of the matrix.

In some previous approaches, the IOE device can be implemented with a buffered architecture to allow the crossbar switch to function. In this implementation, all the signals from host to NAND and vice-versa are buffered inside the IOE die and distributed to a desired port of the crossbar switch. In these approaches, the load or load average between the host and the NAND can decrease as a larger quantity of NAND die is added to the system. That is, a previous IOE will have a lower load capability between the host and the NAND as a greater quantity of NAND dies are added to the system.

In some previous approaches, the IOE device is limited to a particular quantity of NAND die. For example, the IOE can have a feature register that can be utilized to address an incoming bit string at a front end of the IOE to a particular NAND die at the back end of the IOE. In some previous approaches, the ONFI standard supports a feature address of 8-bit resulting in 1 kilobyte (KB) of feature register space. In these approaches, the 1 KB of feature address space may not be sufficient to support the configuration for an IOE device that is coupled to a quantity of greater than or equal to 8 NAND die or LUNs on the back end. In this way, the previous approaches can be limited to the quantity of NAND die or LUNs that can be supported on the back end and/or accessible by a host coupled to the front end.

Aspects of the present disclosure address the above and other deficiencies by employing an IOE device that utilizes IO expander register addressing. For instance, aspects of the present disclosure can utilize a register addressing component along with a feature register that is divided into a first feature register portion and a second feature register portion. In these embodiments, the feature register can be expanded from a single 1 KB portion (as is prevalent in current approaches) to a plurality of 1 KB portions. In this way, the present disclosure allows for the support of the ONFI standard while increasing the quantity of NAND dice that the IOE can support, due to the greater number of registers that the IOE provides accessibility to during operation. In some embodiments, one or more of the feature register portions include an address decode bit written to the register to select one of the plurality of feature register portions.

FIG. 1 illustrates an example computing system that includes a memory sub-system 110 in accordance with some embodiments of the disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single-level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, a MLC portion, a TLC portion, a QLC portion, and/or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

As described above, the memory components can be memory dice or memory packages that form at least a portion of the memory device 130. In some embodiments, the blocks of memory cells can form one or more “superblocks.” As used herein, a “superblock” generally refers to a set of data blocks that span multiple memory dice and are written in an interleaved fashion. For instance, in some embodiments each of a number of interleaved NAND blocks can be deployed across multiple memory dice that have multiple planes and/or pages associated therewith. The terms “superblock,” “block,” “block of memory cells,” and/or “interleaved NAND blocks,” as well as variants thereof, can, given the context of the disclosure, be used interchangeably.

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140. For instance, in some embodiments, the memory device 140 can be a DRAM and/or SRAM configured to operate as a cache for the memory device 130. In such instances, the memory device 130 can be a NAND.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device. The memory sub-system 110 can also include additional circuitry or components that are not illustrated.

The memory sub-system 110 can include a register addressing component 113, which may be referred to in the alternative as a “controller,” herein. Although not shown in FIG. 1 so as to not obfuscate the drawings, the register addressing component 113 can include various circuitry to facilitate aspects of IOE expander register addressing, as detailed herein. In some embodiments, the register addressing component 113 can include special purpose circuitry in the form of an ASIC, FPGA, state machine, and/or other logic circuitry that can allow the register addressing component 113 to orchestrate and/or perform the operations described herein.

In some embodiments, the memory sub-system controller 115 includes at least a portion of the register addressing component 113. For example, the memory sub-system controller 115 can include a processor 117 (processing device) configured to execute instructions stored in local memory 119 for performing the operations described herein. In some embodiments, the register addressing component 113 is part of the memory sub-system 110, an application, or an operating system.

In a non-limiting example, an apparatus (e.g., the computing system 100) can include a register addressing component 113. The register addressing component 113 can be resident on the memory sub-system 110. As used herein, the term “resident on” refers to something that is physically located on a particular component. For example, the register addressing component 113 being “resident on” the memory sub-system 110 refers to a condition in which the hardware circuitry that comprises the register addressing component 113 is physically located on the memory sub-system 110. The term “resident on” can be used interchangeably with other terms such as “deployed on” or “located on,” herein.

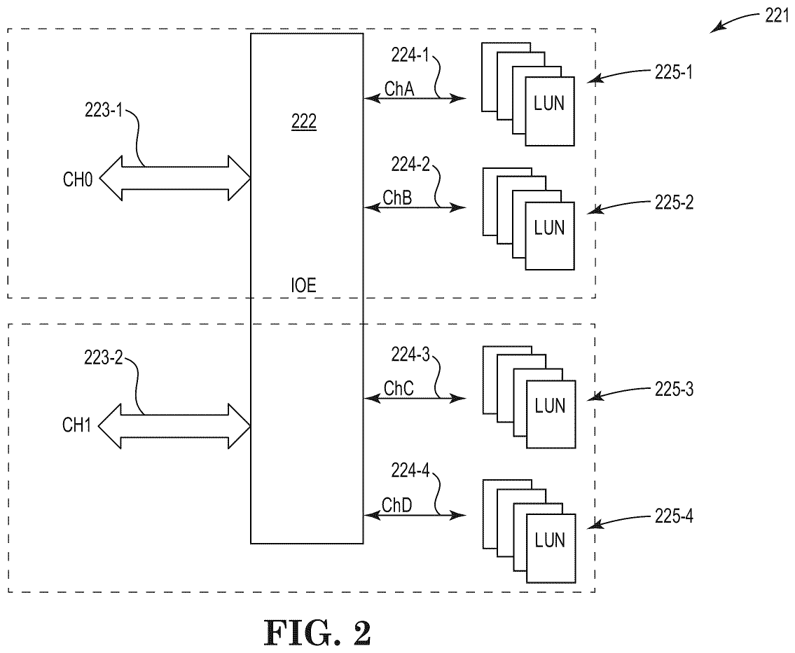

As described further herein with reference to FIG. 2-FIG. 6, the memory sub-system 110 can include an IOE device that includes a feature register comprising a first feature register portion and a second feature register portion. In this embodiment, the first feature register portion and the second feature register portion are designated to a single output channel. In these embodiments, the first feature register portion is a first designated memory address map and the second feature register portion is a second designated memory address map. For example, the first designated memory address map can include a first 1 kilobyte address map and the second designated memory address map can include a second 1 kilobyte address map. In this example, the ONFI standard can be a feature register with a 1 kilobyte address map and thus the IOE device can comply with the ONFI standard while also providing additional feature register space to allow for additional memory resources to be seen by a host.

In some embodiments, the memory sub-system 110 includes a decoder coupled to a first input of the first feature register portion and a second input of the second feature register portion. In these embodiments, the memory sub-system 110 includes an address decode bit written to the first feature register portion to designate a selection between the first feature register portion and the second feature register portion. In some embodiments, the register addressing component 113 can be configured to write the address decode bit to the first feature register portion.

Although two feature address portions are described, the disclosure is not so limited. For example, a plurality of additional feature register portions can be designated and a decoder with the capability to provide signals to each of the additional feature register portions can be utilized. In this example, the register addressing component 113 can be write or encode the address decode bit to a particular feature register portion to designate the selection of the plurality of feature register portions and/or an order of selecting from the plurality of feature register portions. In this way, the decoder can provide signals from a host to a particular feature register portion within the feature register based on the address decode bit.

FIG. 2 illustrates a system 221 that includes a multi-channel input/output (IO) expander (IOE device) 222 in accordance with some embodiments of the disclosure. The IOE device 222 can include a device that utilizes a first input channel 223-1 and a second input channel 223-2 that can be connected to a host device or host system. In some embodiments, the IOE device 222 can operate in a one channel mode and/or a two channel mode. In these embodiments, the IOE device 222 can utilize only the first input channel 223-1 in the one channel mode and utilize both the first input channel 223-1 and the second input channel 223-2 in the two channel mode. In some embodiments, the second input channel 223-2 is disabled to execute a one channel mode utilizing the first input channel 223-1.

In some embodiments, the IOE device 222 can include a first plurality of output channels 224-1, 224-2 and a second plurality of output channels 224-3, 224-4. In some embodiments, a first output channel 224-1 can be coupled to a first portion of LUNs 225-1, a second output channel 224-2 can be coupled to a second portion of LUNs 225-2, a third output channel 224-3 can be coupled to a third portion of LUNs 225-3, and a fourth output channel 224-4 can be coupled to a fourth portion of LUNs 225-4. In a one channel mode, the first input channel 223-1 can be utilized to access the plurality of LUNs 225-1, 225-2, 225-3, 225-4. In a two channel mode, the first input channel 223-1 can be utilized to access the first portion of LUNs 225-1 and the second portion of LUNs 225-2 through the first plurality of output channels 224-1, 224-2 and the second input channel 223-2 can be utilized to access the third portion of LUNs 225-3 and the fourth portion of LUNs 225-4 through the second plurality of output channels 224-3, 224-4.

In some previous embodiments, each of the first plurality of output channels 224-1, 224-2 and the second plurality of output channels 224-3, 224-4 can utilize a feature register for addressing signals from the first input channel 223-1 and/or the second input channel 223-2. As described herein, the feature register can be an industry standard (e.g., ONFI standard, 1 kilobyte standard, etc.). In these embodiments, the quantity of LUNs 225-1, 225-2, 225-3, 225-4 can be limited to a quantity due to the size of the feature register. In this way, the present disclosure can be utilized to expand the quantity of LUNs 225-1, 225-2, 225-3, 225-4 by utilizing a plurality of feature register portions for each of the first plurality of output channels 224-1, 224-2 and the second plurality of output channels 224-3, 224-4.

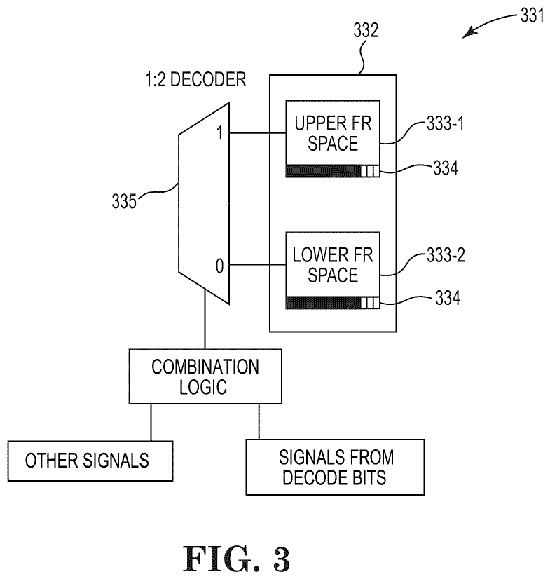

FIG. 3 illustrates a device 331 for IO expander register addressing in accordance with some embodiments of the disclosure. The device 331 can be a portion of an IOE device (e.g., IO expander 222 as referenced in FIG. 2, etc.). The device 331 can include a feature register 332. The feature register 332 can include memory resources that can be utilized to register address information for signals provided between a host device and a plurality of LUNs.

The device 331 can include a decoder 335 that can provide a signal received from a host or other circuitry to the feature register 332. In some examples, the decoder 335 can be utilized to provide a signal from the host to one of a first feature register portion 333-1 or the second feature register portion 333-2. In this way, the decoder 335 can provide a first signal received from the host to the first feature register portion 333-1 and a second signal received from the host to the second feature register portion 333-2. In this embodiment, the decoder 335 can alternate between the first feature register portion 333-1 and the second feature register portion 333-2 to allow additional feature register resources while still providing the standard feature register resources. For example, the first feature register portion 333-1 can be a standard feature register size and the second feature register portion 333-2 can be a standard feature register size; however, by providing two such register portions and allowing access to each based on commands and/or signaling received by the device 331, as described herein, aspects of the present disclosure can allow for an increase in the overall amount of feature register resources available to the IOE device while maintaining backwards compatibility with the ONFI standard.

In some embodiments, the first feature register portion 333-1 and/or the second feature register portion 333-2 can include an address decode bit 334. The address decode bit 334 can be a bit string written to the first feature register portion 333-1. The address decode bit 334 can be utilized to instruct the decoder 335 on selecting between the first feature register portion 333-1 and the second feature register portion 333-2 for a particular signal received at the decoder 335. In this way, the host is able to send signals as if a single feature register with a standard size is utilized. Although the decoder 335 illustrated in FIG. 3 is a 1:2 decoder, embodiments are not so limited and other decoder architectures are contemplated within the scope of the disclosure. In some embodiments, the device 331 can include combination logic that can be utilized to provide signals from the decode bit 334 and/or other devices (e.g., other signals, etc.).

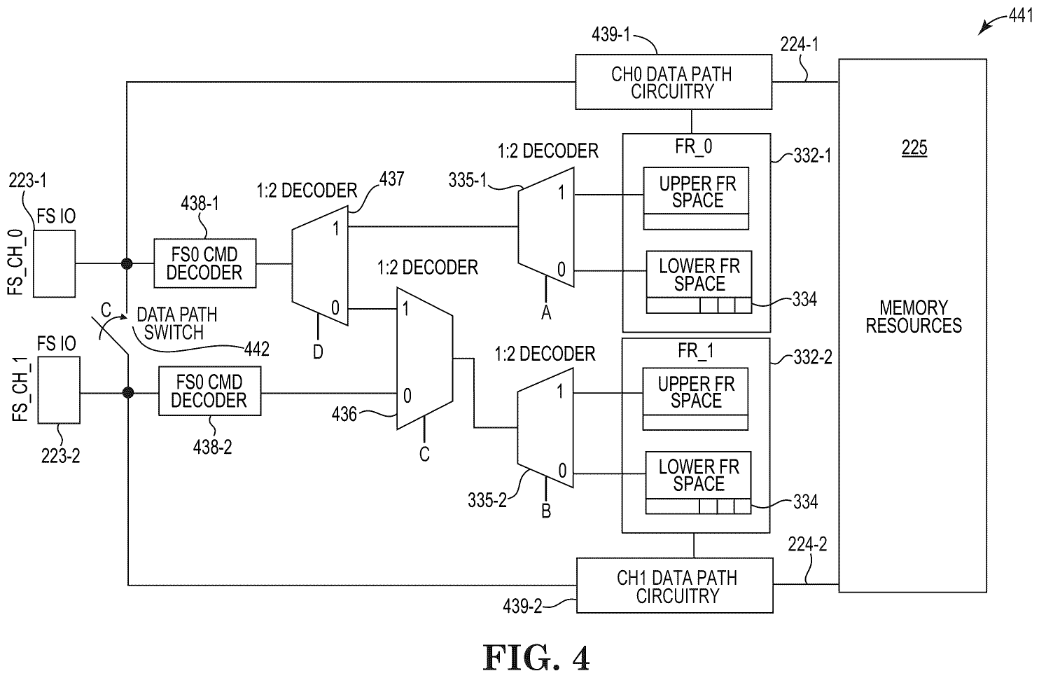

FIG. 4 illustrates a system 441 for IO expander register addressing in accordance with some embodiments of the disclosure. The system 441 corresponds to a circuit diagram of an IOE device (e.g., IO expander 222 as referenced in FIG. 2, etc.). In some embodiments, the system 441 can include a first input channel 223-1 and a second input channel 223-2. As described herein, the first input channel 223-1 and/or the second input channel 223-2 can be utilized by a host to communicate with memory resources 225 (e.g., NAND devices, LUNs, etc.). In some embodiments, the system 441 can include a data path switch 442 that can be part of a first portion of IOE data path circuitry 439-1 and/or a second portion of IOE data path circuitry 439-2.

In some embodiments, the first input channel 223-1 can be coupled to a first command decoder 438-1 and the second input channel 223-2 can be coupled to a second command decoder 438-2. As used herein, a command decoder can be utilized to break a command into a plurality of portions that can be provided to circuitry. For example, the first command decoder 438-1 can be utilized to divide a command or bit string from the first input channel 223-1 into a plurality of portions that are provided to multiplexor 436. In a similar way, the second command decoder 438-2 can be utilized to divide a command or bit string from the second input channel 223-2 into a plurality of portions that are provided to a multiplexor 436 (MUX).

In some embodiments, the decoder 437 can be a 1:2 decoder that can provide a single input to one of two outputs. That is, the decoder 437 can receive an input signal from the first command decoder 438-1 and provide an output signal to one of a first feature register decoder 335-1 or to the multiplexor 436. In some embodiments, the decoder 437 can receive signals at an input “D”. The signals can be received at the input “D” from address decode bit 334, combined signals from the address decode bit 334 and signals from input “C” of multiplexor 436, and/or combined signals from the address decode bit 334 and signals from other devices.

The multiplexor 436 can be a component that can receive multiple input signals and provide a single output signal. For example, the multiplexor 436 can receive signals from the second command decoder 438-2 and/or the decoder 437. In this way, the multiplexor 436 can receive signals from both of the first input channel 223-1 and the second input channel 223-2. The multiplexor 436 can provide received signals to the second feature register decoder 335-2. In some embodiments, the multiplexor 436 can include an input “C” that can be utilized to receive a front side mode select signal. For example, the input “C” can receive a single channel mode or a dual channel mode as described herein.

As described herein, the first feature register decoder 335-1 can be utilized to provide signals to a first feature register 332-1 and the second feature register decoder 335-2 can be utilized to provide signals to a second feature register 332-2. As described in reference to FIG. 3. The first feature register decoder 335-1 can provide the signals to one of a first feature register portion or a second feature register portion of the first feature register 332-1. In a similar way, the second feature register decoder 335-2 can provide the signals to one of a third feature register portion or a fourth feature register portion of the second feature register 332-2. In some embodiments, the first feature register decoder 335-1 can include an input “A” that can receive signals from the address decode bit 334 and/or optionally receive signals from other devices. In a similar way, the second feature register decoder 335-2 can include an input “B” that can receive signals from the address decode bit 334 and/or optionally receive signals from other devices.

In some embodiments, the first feature register portion of the first feature register can include a first address decode bit (e.g., an address decode bit 334 as referenced in FIG. 3, etc.) that can be utilized to select a particular feature register portion to receive a particular signal from the first feature register decoder 335-1. For example, the first address decode bit can select the first feature register portion of the first feature register 332-1 to receive a first signal and select a second feature register portion of the first feature register 332-2 to receive a second signal.

As described herein, the first feature register 332-1 with the first feature register portion and the second feature register portion can be coupled to the first portion of IOE data path circuitry 439-1 that is coupled to a first portion of LUNs (e.g., first portion of the memory resources 225, etc.). This coupling between the first feature register 332-1 and the first portion of IOE data path circuitry 439-1 can be used by the host to adjust and optimize the attributes of the first portion of IOE data path circuitry 439-1. Optimization of first portion of IOE data path circuitry 439-1 attributes may be done for example, to fine-tune timings through the data path circuitry to support higher data transfer speeds between the host and the LUNs or vice-versa. In a similar manner, the second feature register 332-2 with the third feature register portion and the fourth feature register portion can be coupled to the second portion of IOE data path circuitry 439-2 that is coupled to a second portion of LUNs (e.g., second portion of the memory resources 225, etc.).

In some embodiments, the first input channel 223-1 can be utilized by a host to send signals through the first portion of IOE data path circuitry 439-1 to the first set of output channels 224-1. In this way, the host can communicate with a first portion of the memory resources 225 (e.g., LUNs, etc.) through the first set of output channels 224-1. In a similar way, the second input channel 223-2 can be utilized by the host to send signals through the second portion of IOE data path circuitry 439-2 to the second set of output channels 224-2. In this way, the host can communicate with a second portion of the memory resources through the second set of output channels 224-2. In some embodiments, the first input channel 223-1 can be utilized by the host to send signals through the second feature register 332-2 utilizing the multiplexor 436. In this way, the host can adjust the attributes of the second portion of IOE data path circuitry 439-2, enabling optimal communications between the host and the second portion the memory resources 225 through the second set of output channels 224-2.

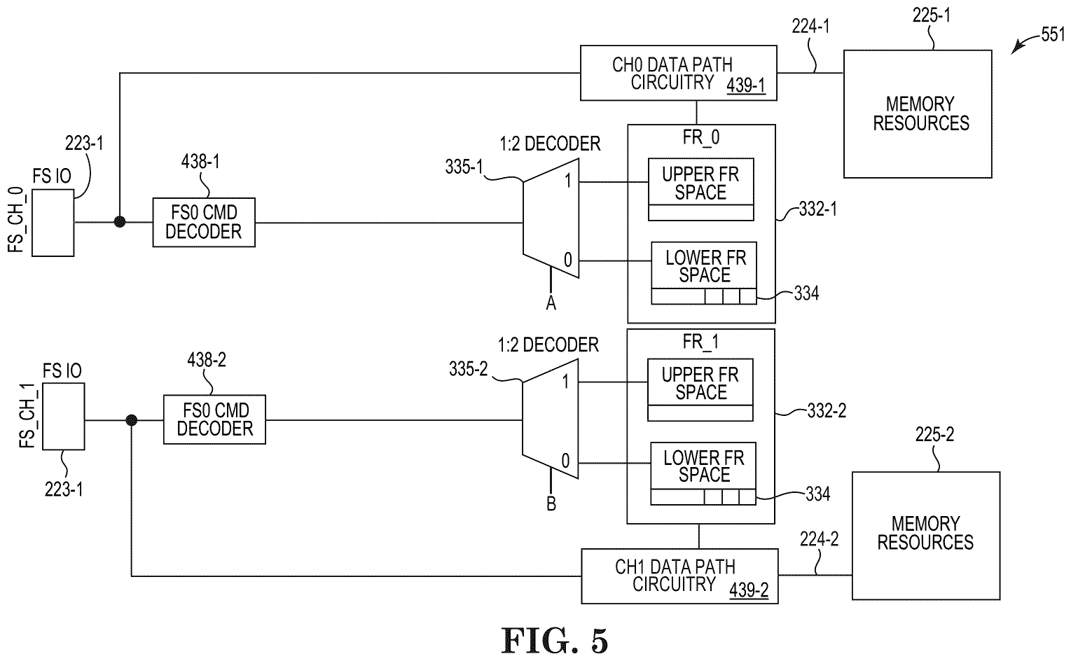

FIG. 5 illustrates a system 551 for IO expander register addressing in accordance with some embodiments of the disclosure. The system 551 can include the same or similar elements as system 441 as referenced in FIG. 4. For example, the system 551 can illustrate an IOE device (e.g., IOE 222 as referenced in FIG. 2) that utilizes the device 331 as referenced in FIG. 3.

In some embodiments, the system 551 includes a first input channel 223-1 and a second input channel 223-2 that can be coupled to a host device or host system. In some embodiments, the first input channel 223-1 and the second input channel 223-2 can be referred to as a front end of the system 551. In some embodiments, the host device can provide signals (e.g., write operations, read operations, bit strings, etc.) to the first input channel 223-1 and/or the second input channel 223-2. In these embodiments, the signals provided to the first input channel 223-1 can be provided to a first command decoder 438-1 and the signals provided to the second input channel 223-2 can be provided to a second command decoder 438-2.

The signals at the first command decoder 438-1 can be provided to a first feature register decoder 335-1. As described herein, the first feature register decoder 335-1 can include a plurality of outputs to provide the signal from the first command decoder 438-1 to one of a plurality of feature register portions of a first feature register 332-1. In a specific example, the first feature register decoder 335-1 is a 1:2 decoder that can receive a signal from the first command decoder 438-1 and provide the signal to one of two feature register portions. As described herein, one of the feature register portions can include an address decode bit that is written to the one of the feature register portions. In these embodiments, the address decode bit can be utilized to select which of the plurality of feature register portions receive the signal from the feature register decoder 335-1. In this way, the feature register decoder 335-1 can provide a first signal to a first feature register portion of the first feature register 332-1 and provide a second signal to a second feature register portion of the first feature register 332-1.

The signals from the first feature register 332-1 can be provided to a first portion of IOE data path circuitry 439-1 that are coupled to a first set of output channels 224-1 that are coupled to a first portion of memory resources 225-1. As described herein, the first set of output channels 224-1 can include a plurality of output channels that can each be coupled to a portion of the first portion of memory resources 225-1. For example, a first output channel of the first set of output channels 224-1 can be coupled to a first set of LUNs and a second output channel of the first set of output channels 224-1 can be coupled to a second set of LUNs.

In a similar way as the first input channel 223-1, the second input channel 223-2 can be utilized by the host to provide signals to the second command decoder 438-2. Signals from the second command decoder 438-2 can be provided to the second feature register decoder 335-2. The second feature register decoder 335-2 can provide the signals from the second command decoder 438-2 to one of a plurality of feature register portions of the second feature register 332-2 based on an address decode bit written to one of the plurality of feature register portions. The signals from the feature register portions can be provided to the second portion of IOE data path circuitry 439-2 coupled to the second set of output channels 224-2, coupled to the second portion of memory resources 225-2.

FIG. 5 can illustrate when an IOE device is operating in a two channel mode. As described herein, the two channel mode can allow a first input channel 223-1 to be utilized to communicate with a first portion of memory resources 225-1 and allow a second input channel 223-2 to be utilized to communicate with a second portion of memory resources 225-2. In some embodiments, the memory resources 225-1 and/or 225-2 can include one or more LUNs as described above in connection with FIG. 2.

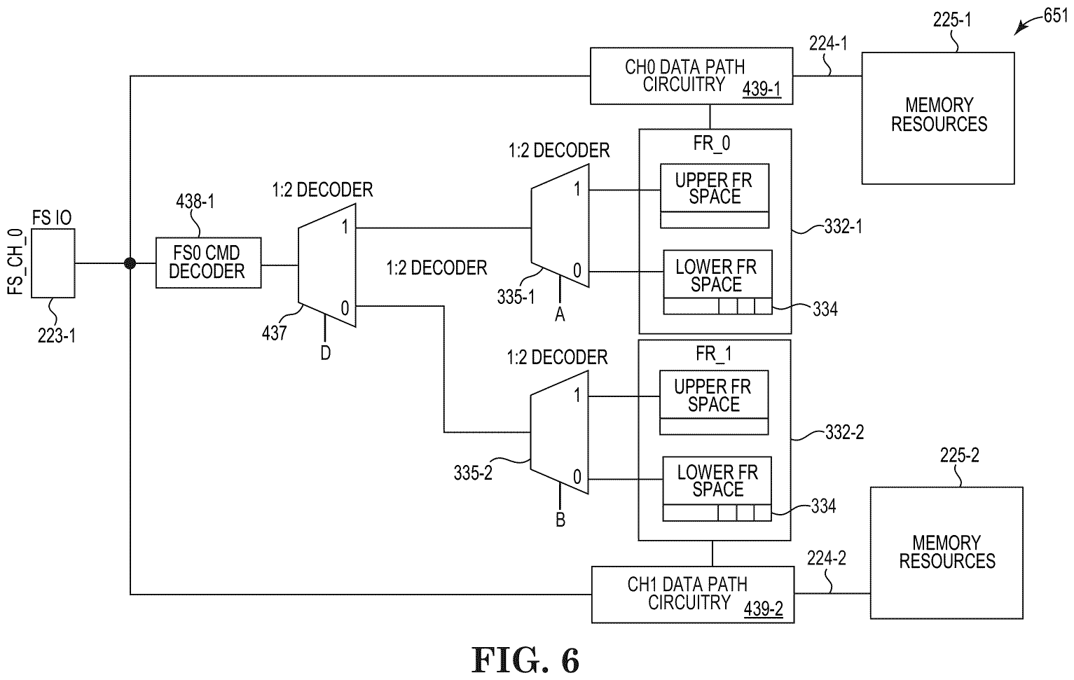

FIG. 6 illustrates a system 661 for IO expander register addressing in accordance with some embodiments of the disclosure. The system 661 can include the same or similar elements as system 441 as referenced in FIG. 4 and system 551 as referenced in FIG. 5. For example, the system 661 can illustrate an IOE device (e.g., IOE 222 as referenced in FIG. 2) that utilizes the device 331 as referenced in FIG. 3. FIG. 6 can illustrate when the IOE device is operating in a single channel mode or a one channel mode. In this way, the first input channel 223-1 can be utilized to communicate with the first portion of memory resources 225-1 and the second portion of memory resources 225-2. In some embodiments, the one channel mode can indicate that the second input channel 223-2 as referenced in FIG. 5, is deactivated.

In some embodiments, the system 661 includes a first input channel 223-1 that can be coupled to a host device or host system. In some embodiments, the host device can provide signals (e.g., write operations, read operations, bit strings, etc.) to the first input channel 223-1. In these embodiments, the signals provided to the first input channel 223-1 can be provided to a first command decoder 438-1.

The signals at the first command decoder 438 can be provided to a decoder 437. The decoder 437 can be utilized to provide the signals to one of the first feature register decoder 335-1 or the second feature register decoder 335-2. In some embodiments, the signals directed to the first portion of memory resources 225-1 pass through the first portion of IOE data path circuitry 439-1 whose attributes are controlled by the first feature register 332-1, and the signals directed to the second portion of memory resources 225-2 pass through the second portion of IOE data path circuitry 439-2 whose attributes are controlled by the second feature register 332-2.

As described herein, the first feature register decoder 335-1 can include a plurality of outputs to provide the signal from the decoder 437 to one of a plurality of feature register portions of a first feature register 332-1. As described herein, one of the feature register portions can include an address decode bit that is written to the one of the feature register portions. In these embodiments, the address decode bit can be utilized to select which of the plurality of feature register portions receive the signal from the feature register decoder 335-1. In this way, the feature register decoder 335-1 can provide a first signal to a first feature register portion of the first feature register 332-1 and provide a second signal to a second feature register portion of the first feature register 332-1.

The signals from the first feature register 332-1 can be provided to a first portion of IOE data path circuitry 439-1 that is coupled to a first set of output channels 224-1 that are coupled to a first portion of memory resources 225-1. As described herein, the first set of output channels 224-1 can include a plurality of output channels that can each be coupled to a portion of the first portion of memory resources 225-1. For example, a first output channel of the first set of output channels 224-1 can be coupled to a first set of LUNs and a second output channel of the first set of output channels 224-1 can be coupled to a second set of LUNs.

In a similar way, signals from the decoder 437 that are provided to the second feature register decoder 335-2 can be provided to one of a plurality of feature register portions of the second feature register 332-2 based on an address decode bit written to one of the plurality of feature register portions. The signals from the feature register portions can be provided to a second portion of IOE data path circuitry 439-2 that is coupled to a second set of output channels 224-2 to be provided to the second portion of memory resources 225-2.

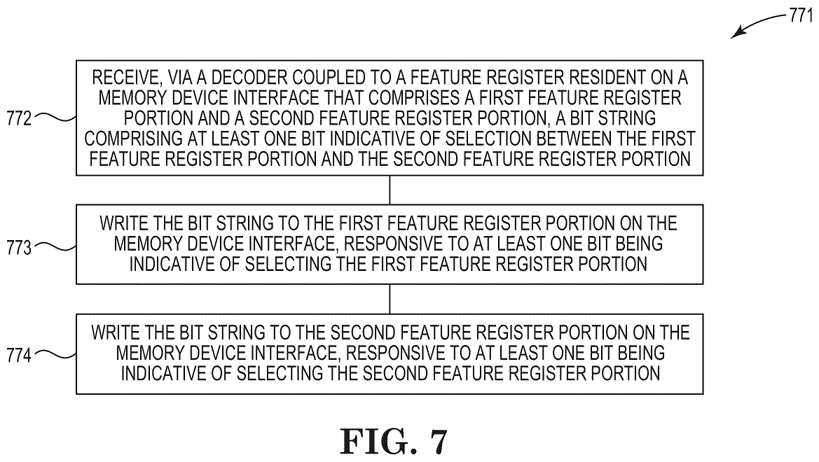

FIG. 7 is a flow diagram corresponding to a method 771 for IO expander register addressing in accordance with some embodiments of the disclosure. The method 771 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 771 is performed by the register addressing component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 772, the method 771 can include receiving, via a decoder coupled to a feature register resident on a memory device interface that comprises a first feature register portion and a second feature portion, a bit string comprising at least one bit indicative of selection between the first feature register portion and the second feature register portion. As described herein, the decoder can be a feature register decoder (e.g., feature register decoders 335-1, 335-2, etc.) that can receive signals from a input channel or other circuitry. The input of the decoder can be coupled to an input channel that is coupled to a host device and an output of the decoder can be coupled to a feature register.

As described herein, the feature register can include at least a first feature register portion and a second feature register portion. One of the feature register portions can include a bit string such as an address decode bit to select the feature register portion to receive a particular signal from the decoder. In this way, the decoder can distribute signals to the plurality of feature register portions based on the bit string. In this way, additional feature register resources can be utilized while still maintaining an industry standard for feature register size (e.g., 1 kilobyte, etc.). That is, each of the plurality of feature register portions can be an industry standard size or quantity of memory resources and operate as a single feature register with the industry standard size.

At operation 773, the method 771 can be executed to write the bit string to the first feature register portion of the memory device interface responsive to the at least one bit being indicative of selecting the first feature register portion. In some embodiments, a signal is received by the encoder and provided to the first feature register portion when the bit string or address decode bit selects the first feature register portion. In these embodiments, the signal is stored by the first feature register portion before being provided to a first portion of IOE data path circuitry of the IOE device.

At operation 774, the method 771 includes writing the bit string to the second feature register portion of the memory device interface responsive to the at least one bit being indicative of selecting the second feature register portion. In some embodiments, a signal is received by the encoder and provided to the second feature register portion when the bit string or address decode bit selects the second feature register portion. In these embodiments, the signal is stored by the second feature register portion before being provided to a second portion of IOE data path circuitry of the IOE device.

As described herein, the first feature register portion is a first designated memory address map and the second feature register portion is a second designated memory address map. In some embodiments, the first feature register portion and the second feature register portion are designated to the first portion of IOE data path circuitry coupled to a single output channel. As described herein, the quantity of LUNs or memory resources coupled to an output channel can be limited by the feature register. In order to expand the quantity of LUNs that can be utilized for a particular output channel, the first feature register portion and the second feature register portion can be coupled to same IOE data path circuitry. In some embodiments, the method 771 includes directly accessing one of the first feature register portion or the second feature register portion based on the address decode bit. As described herein, the first feature register portion can be directly accessed when the address decode bit selects the first feature register portion and the second feature register portion can be directly accessed when the address decode bit selects the second feature register portion.

In some embodiments, the method 771 includes receiving a signal from a first input channel at an input of the decoder. In these embodiments, the method 771 can include receiving the signal at the input of the decoder from a multiplexor coupled to the first input channel and to a second input channel. As described herein, a multiplexor can be utilized to allow a first input channel to access a plurality of feature registers. In these embodiments, each of the plurality of feature registers can include feature register portions. In some embodiments, each of the plurality of feature registers can include a feature register portion with an address decode bit to select a feature register portion for receiving particular signals from a decoder.

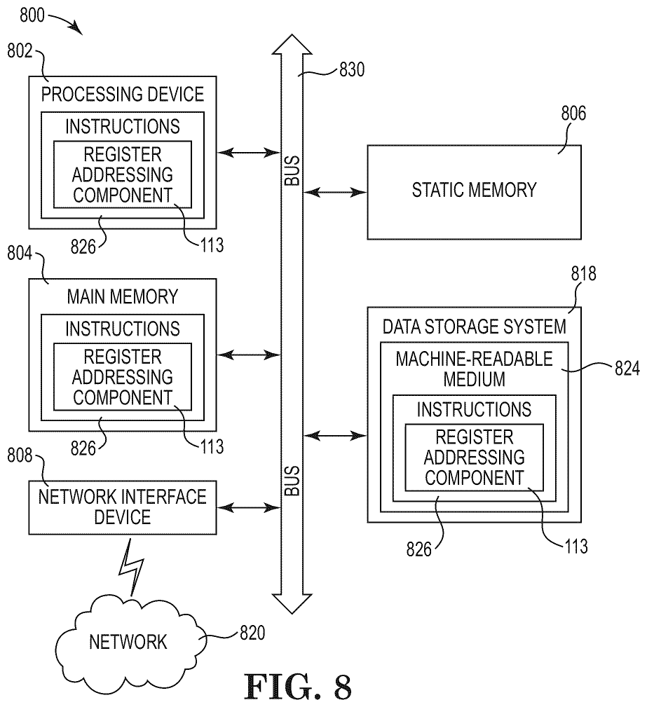

FIG. 8 is a block diagram of an example computer system 800 in which embodiments of the disclosure may operate. For example, FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the register addressing component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

The processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one embodiment, the instructions 826 include instructions to implement functionality corresponding to a register addressing component (e.g., the register addressing component 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer).

In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc. In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, via a decoder coupled to a feature register resident on a memory device interface that comprises a first feature register portion and a second feature portion, a bit string comprising at least one bit indicative of selection between the first feature register portion and the second feature register portion; and
responsive to the at least one bit being indicative of selecting the first feature register portion, writing the bit string to the first feature register portion of the memory device interface, or
responsive to the at least one bit being indicative of selecting the second feature register portion, writing the bit string to the second feature register portion of the memory device interface.

2. The method of claim 1, wherein the first feature register portion and the second feature register portion are designated to circuitry associated to a single output channel.

3. The method of claim 1, further comprising receiving a signal from a first input channel at an input of the decoder.

4. The method of claim 3, further comprising receiving the signal at the input of the decoder from a multiplexor coupled to the first input channel and to a second input channel.

5. The method of claim 1, wherein the first feature register portion is a first designated memory address map and the second feature register portion is a second designated memory address map.

6. The method of claim 5, wherein the first designated memory address map comprises a first 1 kilobyte address map and the second designated memory address map comprises a second 1 kilobyte address map.

7. The method of claim 1, further comprising directly accessing one of the first feature register portion or the second feature register portion based on an address decode bit.

8. An apparatus, comprising:
a controller;
a plurality of memory dice; and
a memory device interface to transfer communication between the controller and the plurality of memory dice, wherein the memory device interface comprises:
a feature register comprising a first feature register portion and a second feature register portion, wherein the first feature register portion and the second feature register portion are designated to circuitry associated to a single output channel;
a decoder coupled to a first input of the first feature register portion and a second input of the second feature register portion; and
an address decode bit written to the first feature register portion to designate a selection between the first feature register portion and the second feature register portion when receiving signals from the decoder.

9. The apparatus of claim 8, wherein the first feature register portion is a standard address map quantity of memory and the second feature register portion is the standard address map quantity of memory.

10. The apparatus of claim 8, comprising a multiplexor, wherein an output of the multiplexor is coupled to an input of the decoder and an input of the multiplexor is coupled to a first input channel and a second input channel.

11. The apparatus of claim 8, comprising a third feature register portion and a fourth feature register portion coupled to an output of an additional decoder.

12. The apparatus of claim 11, comprising an additional address decode bit is written to the third feature register portion to designate a selection between the third feature register portion and the fourth feature register portion when receiving signals from the additional decoder.

13. The apparatus of claim 11, wherein the third feature register portion and the fourth feature register portion are designated to the circuitry associated to a different output channel than the single output channel.

14. The apparatus of claim 8, wherein the memory device interface operates in a one of a one channel mode and a two channel mode.

15. A system comprising:
a memory sub-system comprising a non-volatile memory device; and
a processing device coupled to the memory sub-system by a memory device interface, the memory device interface comprising:
a feature register comprising a first plurality of designated feature register portions designated to circuitry associated with a first set of output channels and a second plurality of designated feature register portions designated to a circuitry associated with a second set of output channels;
a first decoder coupled to a first input of the first plurality of designated feature register portions;
a second decoder coupled to a second input of the second plurality of designated feature register portions;
a multiplexor coupled to an input of the second decoder; and
a third decoder coupled to an input of the first decoder and an input of the multiplexor.

16. The system of claim 15, wherein the processing device is to write a first address decode bit to the first plurality of designated feature register portions to designate a selection between the first plurality of designated feature register portions for signals received from the first decoder.

17. The system of claim 16, wherein the processing device is to write a second address decode bit to the second plurality of designated feature register portions to designate a selection between the second plurality of designated feature register portions for signals received from the second decoder.

18. The system of claim 15, comprising a first input channel coupled to the third decoder and a second input channel coupled to the multiplexor.

19. The system of claim 18, wherein the second input channel is disabled to execute a one channel mode utilizing the first input channel.

20. The system of claim 15, wherein the first set of output channels includes a first output channel coupled to a first portion of NAND dice and a second output channel coupled to a second portion of NAND dice.
